(19) United States
(12) Patent Application Publication
(10) Pub. No.: US 2022/0339549 A1
(43) Pub. Date: Oct. 27, 2022

(54) Wirelessly Coupled Stuffed Toy with Integrated Speaker

(71) Applicant: Ann Johnson, Sanborn, IA (US)

(72) Inventor: Ann Johnson, Sanborn, IA (US)

(21) Appl. No.: 17/386,014

(22) Filed: Jul. 27, 2021

Related U.S. Application Data
(60) Provisional application No. 63/178,839, filed on Apr. 23, 2021.

(51) Int. Cl. A63H 3/00; A63H 3/28; A63H 3/02

(52) U.S. Cl. CPC A63H 3/006; A63H 3/28; A63H 3/02; A63H 2200/00

(57) ABSTRACT

The present invention discloses a wirelessly coupled stuffed toy. The stuffed toy is designed to provide entertainment to pets and/or children. The stuffed toy has a housing comprising a plurality of internal electronic components. More specifically, the stuffed toy has a short-range wireless communication module to connect the toy to a proximal peripheral device. An audio file selected and executed on said peripheral device is played by an internal speaker of the toy. The speaker can also play the music stored in an internal memory of the toy and an internal battery provides power to the speaker.

### CROSS-REFERENCE TO RELATED APPLICATION

The present application claims priority to, and the benefit of, U.S. Provisional Application No. 63/178,839, which was filed on Apr. 23, 2021 and is incorporated herein by reference in its entirety.

### FIELD OF THE INVENTION

The present invention relates generally to the field of toys. More specifically, the present invention relates to a uniquely designed stuffed toy for pets and/or children featuring an internal Bluetooth speaker for playing music. The stuffed toy can be easily paired with a compatible software application installed on an electronic device, which would allow users to upload audio files and music on the software application and thus to select and play the selected music through the paired stuffed toy when the stuffed toy is squeezed. The squeezing of the stuffed toy compresses the Bluetooth speaker and triggers it to play the music selected by the users. Accordingly, this disclosure makes specific reference thereto the present invention. Nonetheless, it is to be appreciated that aspects of the present invention are also equally applicable to other like applications, devices and methods of manufacture.

### BACKGROUND OF THE INVENTION

By way of background, various toys have been developed for the entertainment of pets and/or children. Said toys are generally used for entertaining, motivating, calming down, reducing anxiety and/or soothing pets and/or children. Further, a variety of toys and games such as indoor and outdoor games and/or toys have been devised to keep pets and children engaged and entertained. Standard stuffed toys are also commonly used by children and pets. Although standard stuffed toys can be entertaining for pets and children, they may quickly become bored with these standard stuffed toys.

Further, pet owners can use standard stuffed toys for motivating their pets to exercise or to play. However, standard stuffed toys do not have any additional features to keep pets motivated, and as a result pets may get bored quickly with said standard stuffed toys. Additionally, pets, such as dogs, cats and the like, are more likely to destroy or ruin a toy that doesn't emit sounds, music or the like because they are used to hearing the sounds such as a squeaker.

Therefore, there exists a long-felt need in the art for an improved stuffed toy that keeps children and pets entertained for longer periods of time. There is also a long-felt need in the art for an improved stuffed toy that ensures that children and/or pets do not get bored quickly with the stuffed toy. Further, there is a long felt need in the art for an improved stuffed toy that decreases anxiety amongst children and/or pets, keeps them entertained, motivated and calms them down. Furthermore, there is a long felt need in the art for an improved stuff toy that can be used to motivate pets while they exercise. Finally, there is a long felt need in the art for a stuffed toy specially designed for entertaining and motivating children and/or pets.

The subject matter disclosed and claimed herein, in one embodiment thereof, comprises an improved stuff toy. The toy is comprised of a wireless stuffed toy with an integrated speaker that is configured to provide entertainment to a pet or a child via playing sounds and music. The toy includes a short-range communication module for establishing a short-range wireless channel with a proximal peripheral device, a speaker disposed for playing audio signals, an internal battery for providing power to the speaker, a pressure sensor for sensing pressure when the speaker is squeezed, an internal memory for storing music, a microphone for capturing surrounding sounds and a plurality of LEDs disposed on the exterior surface of the toy. Generally, the audio signals are received from the peripheral device through the established wireless channel or from the internal memory and played via the speaker when the toy is squeezed.

In this manner, the novel stuffed toy of the present invention accomplishes all of the forgoing objectives, and provides a relatively entertaining and exciting toy for children and/or pets. The stuffed toy also plays music for pets and/or children, and ensures that pets and/or children do not get bored quickly while using the stuffed toy.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a stuffed toy. The toy is preferably wirelessly coupled and further comprised of an integrated speaker. The toy is also configured to provide entertainment to a pet and/or a child via playing sounds and music. To accomplish this, the toy is comprised of a short-range communication module for establishing a wireless channel with a proximal peripheral device, a speaker disposed for playing audio signals, an internal battery for providing power to the speaker, a pressure sensor for sensing pressure when the speaker is squeezed, an internal memory for storing music and sounds, a microphone for capturing surrounding sounds and a plurality of LEDs disposed on the exterior surface of the stuffed toy. Typically, the audio signals are received from the peripheral device through the established wireless channel or from the internal memory of the toy. In addition, the speaker can also play out the surrounding sounds captured by a microphone. Typically, the captured sounds are transmitted to a proximal electronic device connected to the stuffed toy using a short-range communication channel and mobile application.

An additional embodiment of the toy may also be comprised of a housing, wherein a plurality of electronic components are disposed within the housing, including a speaker disposed to play audio signals relayed by a built-in short-range communication module or internal memory, and an internal battery for providing power to the speaker. The housing further has a plurality of LEDs disposed on the exterior surface that are illuminated when the speaker plays music.

In yet a further embodiment of the present invention, a method for playing music from a stuffed toy is described. The method includes storing music in an internal memory of the toy, sensing pressure when a built-in speaker is activated by a pressure sensor, and either playing the internally stored music when the pressure is more than a predefined value, or not playing the internally stored music if below a predefined value.

Furthermore, the stuffed toy can resemble any type of doll, animal, object, etc., known in the art to entertain children and/or pets. In addition, the electronic components are housed within the toy to prevent a child or pet from damaging them. The toy can also be used to strengthen sensory, motor and hand and eye coordination skills, and may be manufactured in different colors, shapes and unique designs.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a block diagram showing components of one embodiment of a stuffed toy of the present invention in accordance with the disclosed architecture;

FIG. 2 illustrates a schematic view showing the wireless communication between the stuffed toy of the present invention and a peripheral device in accordance with the disclosed architecture;

FIG. 3 illustrates a block diagram of an exemplary user interface of a software application used for controlling and pairing with the stuffed toy of the present invention in accordance with the disclosed architecture;

FIG. 4 illustrates a schematic view of another embodiment showing wireless communication between one potential embodiment of the stuffed toy of the present invention and a peripheral device with stored music in accordance with the disclosed architecture;

FIG. 5 illustrates a flow diagram disclosing a method for playing the music stored in the internal memory of one potential embodiment of the stuffed toy of the present invention in accordance with the disclosed architecture;

FIG. 6 illustrates a flow diagram disclosing a method for playing the sounds detected by the microphone of one potential embodiment of the stuffed toy of the present invention in accordance with the disclosed architecture; and

FIG. 7 illustrates a perspective view of a dog holding one potential embodiment of a stuffed toy of the present invention in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved stuffed toy that keeps children and/or pets entertained for longer periods of time and has additional features to ensure that children and/or pets remain entertained. Further, there is a long felt need in the art for an improved stuffed toy that decreases anxiety amongst children and/or pets, and keeps them entertained and motivated. Furthermore, there is a long felt need in the art for a modified toy that can be used to motivate pets while they exercise. Finally, there is a long felt need in the art for a stuffed toy specially designed for entertaining and motivating children and/or pets.

The present invention, in one exemplary embodiment, is a novel stuffed toy. The toy is configured to wirelessly communicate with a proximal electronic device using a short-range communication channel. The toy also comprises a housing, a plurality of electronic components disposed within the housing, including a speaker disposed to play audio signals relayed by a built-in short-range communication module or internal memory, and an internal battery for providing power to the speaker. The housing further has a plurality of LEDs disposed on the exterior surface that are illuminated when the speaker plays music.

The term “stuffed toy”, as used herein throughout, includes any toy having flocculent material stuffed interior thereto whereby the toy is compressible, squishy, and yielding, or otherwise suitable for a child and/or a pet. Further, it should be recognized by one of skill in the art that the particular form of the stuffed toy can be any suitable shape or resemble any character, object or animal as is known in the art, such as but not limited to: a doll, an abstract shape, or an animal shape such as a bear, lion, zebra, sheep, monkey, etc. Further, the disclosure sets forth various examples which are not set forth restrictively, but as exemplary disclosures such that the inventive subject matter are better discerned.

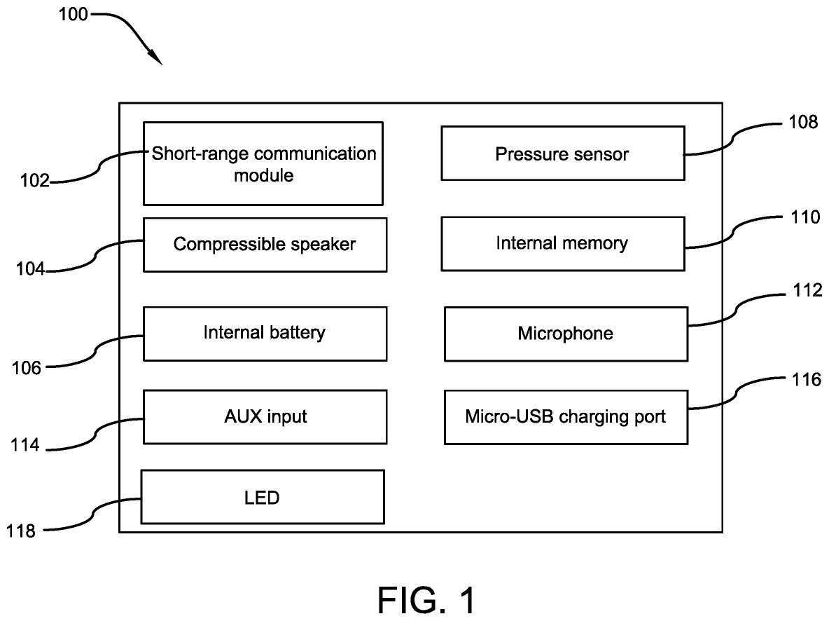

Referring initially to the drawings, FIG. 1 illustrates a block diagram showing components of one embodiment of a stuffed toy 100 of the present invention in accordance with the disclosed architecture. The toy 100 of the present invention can be designed to replicate any type of doll, animal, object, etc., or any other suitable design tailored to entertaining children and pets as is known in the art. The stuffed toy 100 also functions as additional entertainment for a pet or a child by emitting sounds and music. In the preferred embodiment, the toy 100 is comprised of a plurality of electronic components disposed in a housing 702. The plurality of electronic components comprise a short-range communication module 102 that allows the toy 100 to wirelessly connect to a handheld electronic device or a peripheral device 202, such as a smartphone or other smart device via a wireless channel. The wireless connection can be Bluetooth, Infrared, Wi-Fi or any other short-range communication technique known in the art. Further, the short-range communication module 102 is preferably in the form of a transceiver having antennas for receiving the wireless channel. Using the wireless channel, a song or any other music can be received by the toy 100 from the connected handheld electronic device (e.g. peripheral device 202). The toy 100 also is comprised of a speaker 104 having a soft exterior surface that can be compressed. The speaker 104 is embedded within the body of the toy 100 and plays the music and/or sounds received through the wireless channel (or which alternatively have been stored in the internal memory 110) of the toy 100. The speaker 104 is positioned within the housing 702 and has a substantially flexible exterior surface with continuous openings to clearly hear audible sounds played from the speaker 104. The speaker 104 is robust and durable and can be easily compressed or squeezed by a child's hands or a pet's mouth. The internal soft stuffing of the toy 100 further cushions and protects the speaker 104 and does not allow the pet or the child to damage the speaker 104. The speaker 104 and the wireless communication module 102 can also be integrated as a single unit in one embodiment of the present invention.

A pressure sensor 108 is further located within the stuffed toy 100 and is configured to sense the pressure with which the speaker 104 is compressed or squeezed by a pet or child. When the pressure detected by the pressure sensor 108 is greater than a predefined threshold value, then the speaker 104 can emit or play music or other audio files stored in the internal memory 110 of the stuffed toy 100. Additionally, the stuffed toy 100 comprises a built-in microphone 112 which is integrated into the housing 702. The microphone 112 can pick up audible sounds of the pet or the child playing with the stuffed toy 100, wherein the audible sounds picked up by the microphone 112 are then played via the speaker 104 when selected and activated.

Further, the toy 100 may comprise an AUX input 114 present on an exterior surface of the toy 100 at a convenient position for allowing a wired electronic device to be connected, such that the connected device can input songs or music playable by the speaker 104. Audio executed on a connected peripheral device 202 (e.g. a connected smart device) is playable through the built-in speaker when the short-range communication module 102 is connected to and communicating with the peripheral device 202 via a software or mobile application 204. Additionally, when the music or song is played by the speaker 104, a plurality of LEDs 118 located along the interior and/or exterior surface of the stuffed toy 100 provides an external and/or internal illumination of the stuffed toy 100, thus engaging a pet or a child.

The toy 100 also has an internal battery 106 which can be in the form of a button battery or other suitable battery as is known in the art and which provides power to the speaker 104. The battery 106 has a long running life and can be easily replaced. Optionally, a micro-USB charging port 116 may be present on an exterior surface of the stuffed toy 100 at a convenient position for recharging the internal battery 106.

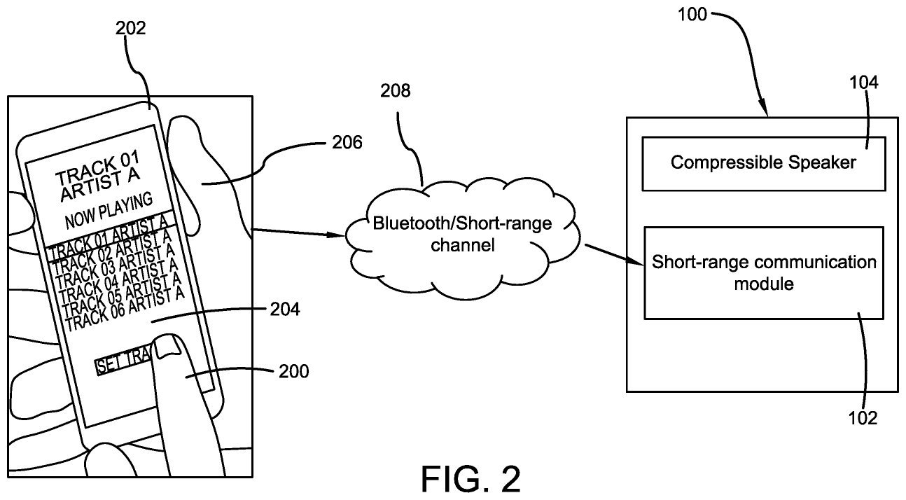

FIG. 2 illustrates a schematic view showing the wireless communication between the stuffed toy 100 of the present invention and a peripheral device 202 (shown as prior art) in accordance with the disclosed architecture. As noted, the toy 100 may be comprised of a specific software application 204 which would be installed and run on a peripheral device 202. A user 200 may utilize the peripheral device 202 to maintain a digital library of audio files and books 206 which can be readily selected and executed for use via the wirelessly connected stuffed toy 100.

Accordingly, the peripheral device 202 having the installed software application 204 allows a user 200 to store a plurality of songs or music, i.e., audio files 206. The music 206 can be selected by the user 200 and playable by the speaker 104 of the stuffed toy 100. The transmission of stored songs or music 206 from the peripheral device 202 is performed using a short-range communication channel 208 established between the wireless transceiver of the peripheral device 202 and the short-range communication module 102 of the stuffed toy 100.

Further, the software application 204 allows a user to select music from the stored music and songs 206 on the peripheral device 202. For example, the stored music and songs 206 accessed via the software application 204 allow parents to soothe their children with heartbeat sounds and/or lullabies. Additionally, various music, songs and audio files can be downloaded to the software application 204 using the Internet.

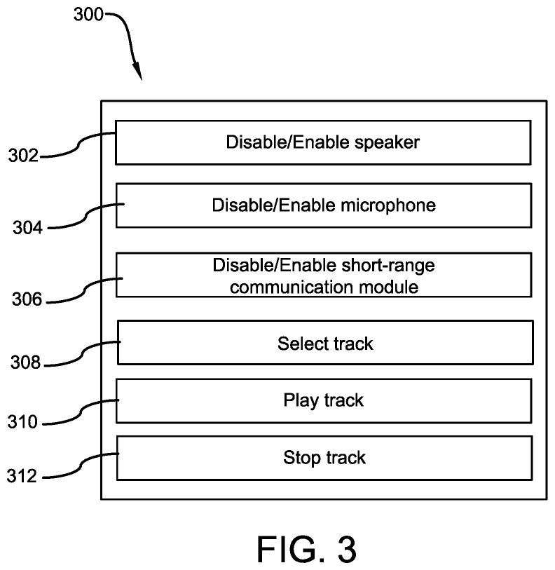

FIG. 3 illustrates a block diagram of an exemplary user interface of a software application 204 used for controlling and pairing with the stuffed toy 100 of the present invention in accordance with the disclosed architecture. The software application 204 provides a plurality of control options that allow a user to pair and play songs using the stuffed toy 100 via a user interface 300. For example, a “Disable/Enable speaker” control 302 allows the user to remotely disable and enable the built-in speaker of the paired stuffed toy 100. This control 302 can be used to disable the speaker easily when a pet or a child sleeps with the stuffed toy 100. A “Disable/Enable microphone” control 304 allows the built-in microphone of the stuffed toy 100 to be disabled or enabled wirelessly. A “Disable/Enable short-range communication module” control 306 allows the user to remotely disable and enable the short-range communication module of the paired stuffed toy 100. This control 306 can be used to disable the wireless connection allowing music in the internal memory of the stuffed toy 100 to be played by the built-in speaker. Additionally, a “Select track” control 308 allows a user to select a track such as a specific song or music to be played through the built-in speaker of the stuffed toy 100. The “Play track” control 310 allows the user to play a selected track and the “Stop track” 312 control allows the user to stop a selected track via the software application 204. It should be noted that the controls provided by the software application 204 provide convenience to a user such as an owner of a pet and/or parent of a child.

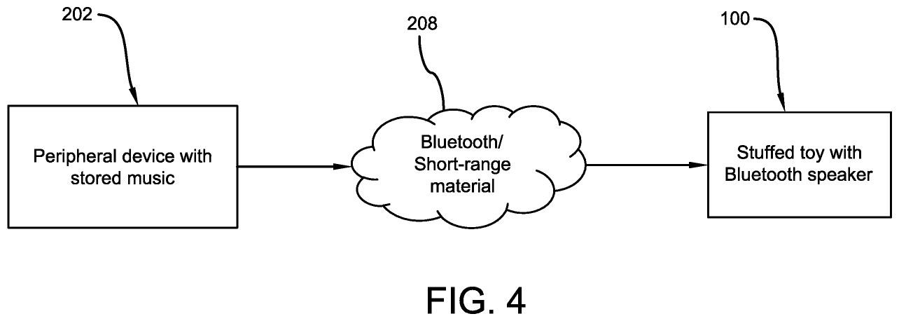

FIG. 4 illustrates a schematic view of another embodiment showing wireless communication between one potential embodiment of the stuffed toy 100 of the present invention and a peripheral device 202 (shown as prior art) with stored music in accordance with the disclosed architecture. The peripheral device 202 in this particular embodiment does not utilize a software application 204, but stores music in the internal memory 110 of the stuffed toy 100 or in a cloud memory associated with the peripheral device 202. Using the wireless communication module of the peripheral device 202, a short-range wireless communication channel 208 is established with the stuffed toy 100. Accordingly, music selected on the peripheral device 202 is played by the built-in speaker of the stuffed toy 100. In the present embodiment, the user can select a track, play or stop a track and can disable the communication channel with the stuffed toy 100 via the peripheral device 202.

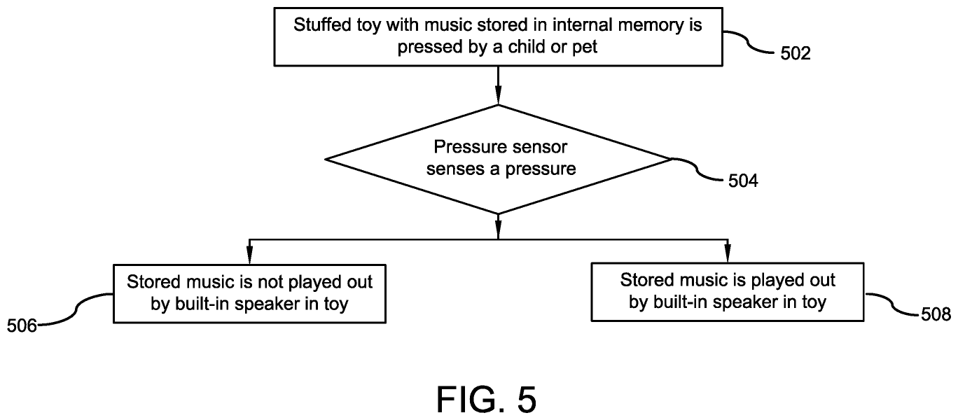

FIG. 5 illustrates a flow diagram disclosing a method for playing the music stored in the internal memory 110 of one potential embodiment of the stuffed toy 100 of the present invention in accordance with the disclosed architecture. Initially, when a peripheral device 202 is not paired with the stuffed toy 100, the toy 100 can still play music when compressed if music has been previously stored in its internal memory 110. For example, at 502 a stuffed toy with music stored in its internal memory is pressed or squeezed by a child or a pet. At 504, the pressure with which the stuffed toy is squeezed is determined by an internal pressure sensor module. If the determined pressure is less than a predetermined threshold, then at 506 the stored music is not played by a built-in speaker 104. However, if the determined pressure is greater than a predetermined threshold, then at 508 the stored music is played by a built-in speaker 104. Additionally, in a differing embodiment the internally-stored music can also be played on a paired peripheral device 202 when the wireless communication channel is established between the stuffed toy 100 and the peripheral device 202.

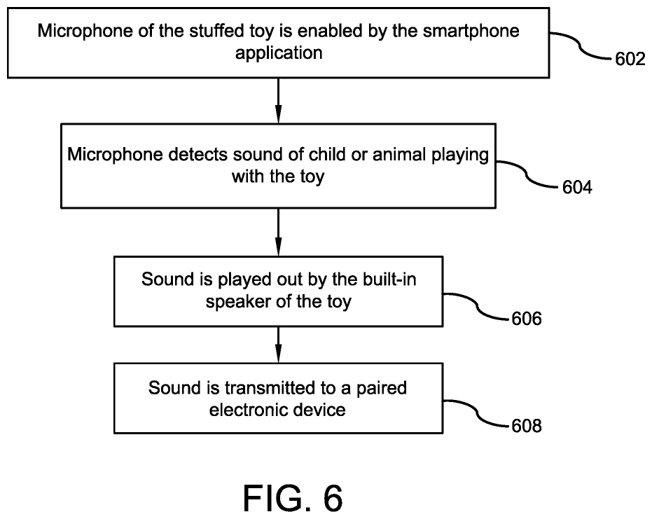

FIG. 6 illustrates a flow diagram disclosing a method for playing the sounds detected by the microphone 112 of one potential embodiment of the stuffed toy 100 of the present invention in accordance with the disclosed architecture. Initially at 602, the built-in microphone of the stuffed toy 100 is enabled by the software/smartphone application 204. The microphone 112 can be enabled or disabled based on defaults determined via preferences of the user. Further, at 604 when the microphone 112 is enabled, the microphone 112 captures various sounds of a child or a pet engaging with the stuffed toy 100. At 606, the sounds captured by the microphone 112 are then played by the built-in speaker 104 of the stuffed toy 100. Simultaneously, if a wireless connection is established between the peripheral device/electronic device 202 and the stuffed toy 100, then at 608 the sounds captured by the microphone 112 are played by the speaker 104 of the peripheral device 202.

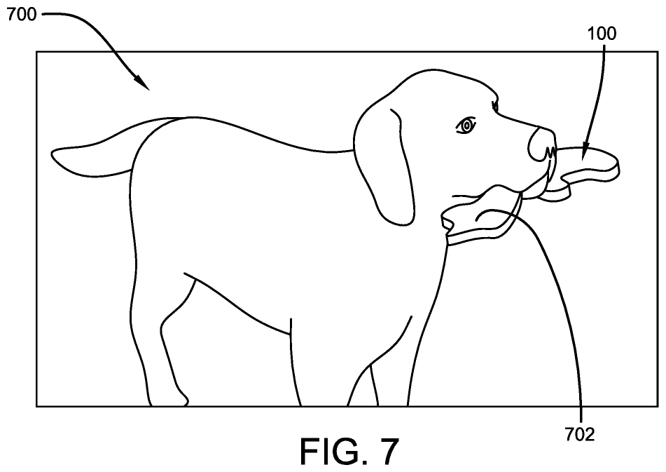

FIG. 7 illustrates a perspective view of a dog holding one potential embodiment of a stuffed toy 100 of the present invention in accordance with the disclosed architecture. The stuffed toy 100 can be easily held in the mouth of a pet, such as a dog 700, using the housing 702 of the stuffed toy 100. Further, the built-in speaker 104 of the stuffed toy 100 plays the songs or music stored internally in the stuffed toy 100 or wirelessly through a peripheral device 202 such as a smartphone or a tablet. For example, the toy 100 can play a welcome message when initially activated, whereby the welcome message would inform a user to connect the toy 100 with a proximal peripheral device 202. Once the connection is established, a confirmation message would then be played, confirming the connection. The welcome message may also include an introduction of the stuffed toy 100, wherein it appears as if the stuffed toy 100 is introducing itself to the user before establishing a connection with a proximal peripheral device 202.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “improved stuffed toy”, “stuffed toy”, and “toy” are interchangeable and refer to the stuffed toy 100 of the present invention.

Notwithstanding the forgoing, the stuffed toy 100 of the present invention can be of any suitable size and configuration as is known in the art without affecting the overall concept of the invention, provided that it accomplishes the above-stated objectives. One of ordinary skill in the art will appreciate that the size, configuration, and material of the stuffed toy with integrated speaker 100 as shown in FIGS. 1-7 is for illustrative purposes only, and that many other sizes and shapes of the stuffed toy 100 are well within the scope of the present disclosure. Although the dimensions of the stuffed toy 100 are important design parameters for user convenience, the stuffed toy 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A stuffed toy comprising:
a housing;
a speaker;
an internal battery;
a microphone for recording an audible sound;
an internal memory; and
a short-range communication module that allows the stuffed toy to be in wireless communication with an electronic device.

2. The stuffed toy of claim 1, wherein the electronic device is a smartphone.

3. The stuffed toy of claim 1 further comprising a plurality of LEDs positioned on an exterior surface of the housing.

4. The stuffed toy of claim 3, wherein the plurality of LEDs are activated when the speaker is activated.

5. The stuffed toy of claim 4 further comprising a pressure sensor that is configured to sense a pressure applied to the speaker by a user.

6. The stuffed toy of claim 5, wherein if the pressure detected by the pressure sensor is greater than a predefined threshold then the speaker emits a sound.

7. The stuffed toy with integrated speaker of claim 6 further comprising a micro-USB charging port positioned on the exterior surface of the stuffed toy for recharging the internal battery.

8. The stuffed toy of claim 7 further comprising an AUX input positioned on the exterior surface for allowing the electronic device to be hardwired to the stuff toy to upload a song to the internal memory.

9. The stuffed toy of claim 8, wherein the microphone records the audible sounds of the user engaging with the stuffed toy, and plays the recorded audible sounds via the speaker.

10. The stuffed toy of claim 9, wherein the electronic device comprises a software application that pairs the stuffed toy to the electronic device.

11. The stuffed toy of claim 10, wherein the software application allows the user to store a plurality of music that can be selected by the user and play through the speaker of the stuffed toy.

12. A method for playing an audible file from a stuffed toy, the method comprising the steps of:
storing the audible file in an internal memory of the stuffed toy;
applying a pressure to an exterior surface of the stuffed toy;
measuring the pressure with which the stuffed toy is compressed; and
playing the audible file via an integrated speaker in the stuffed toy if the pressure applied meets a predetermined threshold.

13. The method of claim 12, wherein the pressure applied to the stuffed toy is determined by an internal pressure sensor in the stuffed toy.

14. The method of claim 13, wherein if the pressure applied to the stuffed toy is less than the predetermined threshold, then the audible file is not played.

15. The method of claim 13, wherein the stuffed toy is comprised of a housing, an internal, a microphone, and a short-range communication module.

16. The method of claim 12, wherein a peripheral device is paired to the stuffed toy via a wireless communication channel.

17. The method of claim 16, wherein the paired peripheral device is used to control a playing of the audible file.

18. The method of claim 17, wherein the paired peripheral device comprises a user interface and a software application.

19. A method for recording and playing an audible sound as a pet or a child engages with a stuffed toy comprising the steps of:
enabling a microphone attached to the stuffed toy via a software application on a remote electronic device;
capturing the audible sound of the pet or the child engaging with the stuffed toy; and
playing the captured audible sound via a speaker attached to the stuffed toy.

20. The method of claim 19, wherein the step of enabling is triggered by a pressure being applied to the stuffed animal, wherein the pressure is detected by a pressure sensor embedded in the stuffed toy.
